(19) United States
(12) Patent Application Publication
(10) Pub. No.: US 2024/0331052 A1
(43) Pub. Date: Oct. 3, 2024

(54) APPARATUS, SYSTEMS, AND METHODS FOR WEATHER EVENT MOBILIZATION AND RESPONSE

(71) Applicant: c/o American Family Mutual Insurance Company, S.I., Madison, WI (US)

(72) Inventors: Benjamin T. Zimmerman, Madison, WI (US); Glenn M. Fung Moo, Madison, WI (US); Michael Beles, Madison, WI (US); Vivekanand Praturi, Madison, WI (US); John Clark, Madison, WI (US); Daniel A. Dickinson, Madison, WI (US)

(21) Appl. No.: 18/737,395

(22) Filed: Jun. 7, 2024

Related U.S. Application Data
(63) Continuation of application No. 16/819,826, filed on Mar. 16, 2020.
(60) Provisional application No. 62/819,532, filed on Mar. 16, 2019.

(51) Int. Cl. G06Q 40/08; G01W 1/10; G06F 16/245; G06N 5/04; G06Q 10/0631; G06Q 10/10; G06Q 30/0204; G06Q 40/02; G06Q 50/26

(52) U.S. Cl. CPC G06Q 40/08; G06F 16/245; G06N 5/04; G06Q 10/06311; G06Q 10/06315; G06Q 10/10; G06Q 30/0205; G06Q 40/02; G01W 1/10; G06Q 50/265

(57) ABSTRACT

In some embodiments, apparatuses and methods are provided herein useful for predicting the time and geographic area of one or more weather events. More specifically, systems, apparatuses and methods are provided herein useful to providing accurate temporal prediction of the volume and location of expected insurance claims resulting from one or more weather events. In some embodiments, these teachings may be employed to predict outcomes such as a number of insurance claims or a monetary value of claim losses associated with a weather event. By one approach, in response to such prediction, these teachings may assist with the generation of responses in preparation for or in response to predicted weather events and insurance claims. For example, in some embodiments, the systems, apparatuses, and methods provided herein may be employed to mobilize resources, send notifications, and generate responses in preparation for or in response to one or more predicted insurance claims.

### CROSS-REFERENCE TO RELATED APPLICATION(S)

This application is a continuation of U.S. application Ser. No. 16/819,826, filed Mar. 16, 2020, and claims the benefit of U.S. Provisional Application No. 62/819,532, filed Mar. 16, 2019, both of which are incorporated herein by reference in their entirety.

### TECHNICAL FIELD

This invention relates generally to the prediction of weather events, and more specifically, to weather events and associated insurance exposure.

### BACKGROUND

Weather events such as large hailstorms, hurricanes, wildfires, and tornadoes can occur with limited forewarning and can result in significant losses in a short period of time. It can, therefore, be difficult for insurance companies to quickly mobilize resources in response to weather events. Accurate temporal and geographic prediction of expected losses resulting from weather events can help with resource planning and mobilization. Previous approaches for identifying potential events typically applied a reactive methodology that relied too heavily on observed weather data, for example data from radar or weather sensors, or incoming insurance claims for analysis. Therefore, a more proactive methodology for the prediction of expected losses and outcomes would help improve the response to such events and facilitate the generation of responses in advance.

### BRIEF DESCRIPTION OF DRAWINGS

Disclosed herein are embodiments of systems, apparatuses and methods pertaining to mobilizing resources and generating responses for weather events. This description includes drawings, wherein:

FIG. 1 is a schematic diagram of a weather event mobilization and response system in accordance with some embodiments.

FIG. 2 is a schematic illustration of an exemplary weather event mobilization and response system in accordance with some embodiments.

FIG. 3 is an exemplary flow diagram in accordance with some embodiments.

FIG. 4 is an exemplary flow diagram in accordance with some embodiments.

FIG. 5 is an exemplary flow diagram in accordance with some embodiments.

FIG. 6 is an exemplary claims data visualization screen in accordance with several embodiments.

FIG. 7 illustrates an exemplary system for use in implementing systems, apparatuses, devices, methods, techniques, and the like for mobilizing and responding to a weather event in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for predicting the time and geographic area of one or more weather events. More specifically, systems, apparatuses and methods are provided herein useful for providing an accurate temporal prediction of the volume and location of expected insurance claims resulting from a weather event. In some embodiments, the systems, apparatuses and methods provided herein may be employed to predict outcomes, such as, for example, a number of insurance claims or a monetary value of claim losses associated with a weather event. In some embodiments, the systems, apparatuses, and methods provided herein may be employed to predict various attributes of one or more insurance claims associated with a weather event. Furthermore, in some embodiments, the systems, apparatuses, and methods provided herein may be employed to mobilize resources, send notifications, and/or generate responses in preparation for or in response to one or more predicted outcomes, such as, likely insurance claims.

By some approaches, a weather event mobilization and response system includes a database, at least one electronic user device having a user interface, and a processor in communication with the database and the at least one electronic user device. The database may include current exposure data and historic weather event data. Historic weather event data may include historic insurance claim data, historic exposure data, historic weather data, and historic insurance claim loss data associated with one or more historic weather events. In such a system, the processor may be configured to receive historic insurance claim data, historic exposure data, historic weather data, and historic claim loss data from the database. Using a weather forecast model, the control circuit may generate historic weather forecast data (i.e., reanalysis data) by analyzing the received historic weather data. Further, using a storm loss model, the control circuit may analyze the historic weather data, the historic insurance claim data, the historic exposure data, the historic claim loss data, and the historic weather forecast data. In one approach, the storm loss model is configured to develop correlations between the historic weather data, the historic weather forecast data, and the historic exposure data and at least one of the historic insurance claim data and the historic claim loss data. The control circuit may also receive current weather data from one or more sensors and may generate current weather forecast data by analyzing the current weather data via the weather forecast model. In addition to receiving current weather data, the control circuit may receive current exposure data from the database. Using correlations developed by the storm loss model and the current weather data, current weather forecast data, and current exposure data, the control circuit may identify one or more weather events. In addition to identifying weather events, the control circuits may use the correlations to determine predicted outcomes, such as, for example, likely insurance claims and/or claim losses associated with the identified weather events. In this manner, the control system may then send instructions for responding to the weather event to at least one electronic user device based on the predicted outcomes (e.g., likely insurance claims and/or claim losses) associated with the identified weather event

By some approaches a weather event mobilization and response system includes a database, at least one electronic user device having a user interface, a processor in communication with the at least one electronic user device and the database. The database may include current exposure data, current weather data, and historic weather event data. Historic weather event data may include historic insurance claim data, historic exposure data, historic weather data, and historic claim loss data associated with one or more historic weather events. In such a system the processor may be configured to receive historic insurance claim data, historic exposure data, historic weather data, and historic claim loss data from the database. Using a weather forecast model, the control circuit may generate historic weather forecast data (i.e., reanalysis data) by analyzing the received historic weather data. Further, using a storm loss model, the control circuit may analyze the historic weather data, the historic insurance claim data, the historic exposure data, the historic claim loss data, and the historic weather forecast data. In one approach, the storm loss model is configured to develop correlations between the historic weather data, the historic weather forecast data, and the historic exposure data and at least one of the historic insurance claim data and the historic claim loss data. The control circuit may also receive current weather data from at least one sensor and generate current weather forecast data by analyzing the current weather data via the weather forecast model. In addition to receiving current weather data, the control circuit may receive current exposure data from the database. Using correlations developed by the storm loss model and the current weather data, current weather forecast data, and current exposure data, the control circuit may identify one or more weather events. In addition to identifying weather events, the control circuits may use the correlations to determine predicted insurance claims and/or claim losses associated with the identified weather events. In this manner, the control circuit may allocate resources for responding to the weather event based on the predicted claims and claim losses associated with the identified weather event.

By some approaches, a method of operating a weather event mobilization and response system may include receiving historic weather event data from a historic weather event database. The historic weather event data may include historic weather data, historic insurance claim data, historic exposure data, and historic claim loss data associated with the historic weather event. In one approach, the historic weather data may include meteorological information collected during or prior to the historic weather event. Next, using a weather forecast model, the system may analyze the historic weather data to generate historic weather forecast data (i.e., reanalysis data) associated with the historic weather event. The system may then analyze the generated historic weather forecast data along with the historic weather data, the historic exposure data, and the historic claim loss data to generate a storm loss model. By some approaches, the system may develop correlations between the historic weather data, the historic exposure data, and the generated historic weather forecast and at least one of the historic insurance claim data and the historic claim loss data associated with the historic weather event. In some approaches, the system may develop correlations via one or more machine learning algorithms. The system may use the storm loss model to analyze current data in order to predict insurance claims and claim losses associated with a weather event. By some approaches, the system may receive current weather data from at least one weather sensor and, using the weather forecast model, the system may analyze the current weather data to generate current weather forecast data. Additionally, the system may receive current exposure data from an insurance policy database. Using correlations in the storm loss model, the system may then identify at least one weather event. Furthermore, the system may determine predicted insurances claims and predicted claim losses associated with the identified weather event using the correlations developed by the storm loss model based on the current weather forecast data and current exposure data. In some approaches, the system may send instructions for responding to the weather event to at least one electronic user device. The instructions may be based, at least in part, on the predicted insurance claims or the predicted claim losses associated with the identified weather event.

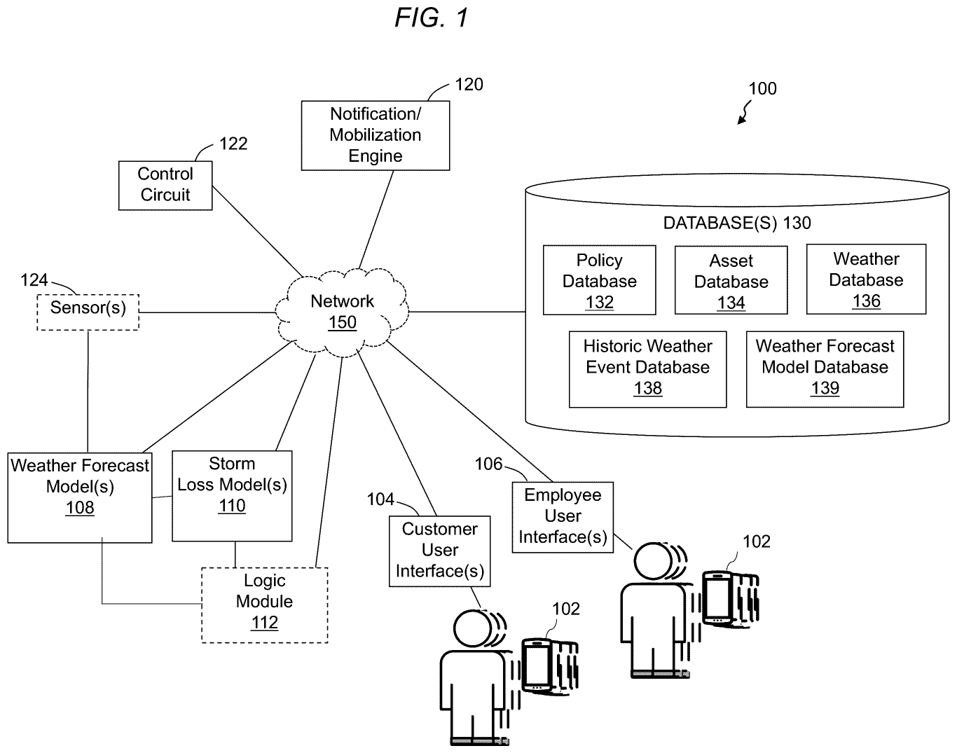

FIG. 1 illustrates a schematic diagram of a weather event mobilization and response system 100 in accordance with some embodiments. The system 100 may be employed to identify and/or predict the time and geographic area of one or more weather events. The system 100 may also facilitate the mobilization of resources and/or the generation of one or more responses in order to prepare for or respond to an identified and/or predicted weather event. The mobilization of resources may include, for example, mobilization of money, manpower, time, assets, and/or physical resources such as raw materials.

To facilitate the mobilization of resources and the generation of responses for weather events, the system 100 includes one or more storm loss models 110 that identify weather events and predicts outcomes, such as insurance claims and/or claim losses, likely to result from the identified weather events. By some approaches, the storm loss models 110 may predict various attributes of predicted insurance claims associated with an identified weather event (e.g., first notice of loss, the time from weather event to claim filing). Additionally, by some approaches, the storm loss model 110 may also predict other outcomes, such as an amount of damage or resource usage, associated with an identified weather event. For example, output of the storm loss model 110 may include the types of insurance claims, the volume of insurance claims, and/or the monetary value of insurance claims likely to result from an identified weather event. The system 100 also includes a notification/mobilization engine 120 that may generate event notifications, mobilize resources, or otherwise generate responses to prepare for and/or respond to an identified weather event based on the predicted outcomes (e.g., predicted insurance claims and claim losses) associated with the weather event. The system 100 further includes one or more electronic user devices 102 that may receive notifications, alerts, reports, maps, instructions, or other data generated by the storm loss model 110 or notification/mobilization engine 120. The electronic user devices 102 may include, for example, a tablet, a smart phone, a laptop, a personal computer device, or a smart watch, etc. One or more user interfaces 104, 106 may be associated with the electronic user devices 102. As shown, a control circuit 122 may be in communication with the electronic user devices 102, the storm loss model 110, and the notification/mobilization engine 120.

In such a configuration, one or more user interfaces 104, 106 may receive notifications, alerts, reports, maps, instructions, or other data generated from the control circuit 122. By some approaches, the notifications, alerts, reports, maps, instructions, or other data may include information generated by the storm loss model 110 regarding predicted insurance claims and claim losses associated with a weather event. By some approaches, the user interfaces 104, 106 may be configured to display one or more notifications, alerts, reports, maps, instructions, or other data.

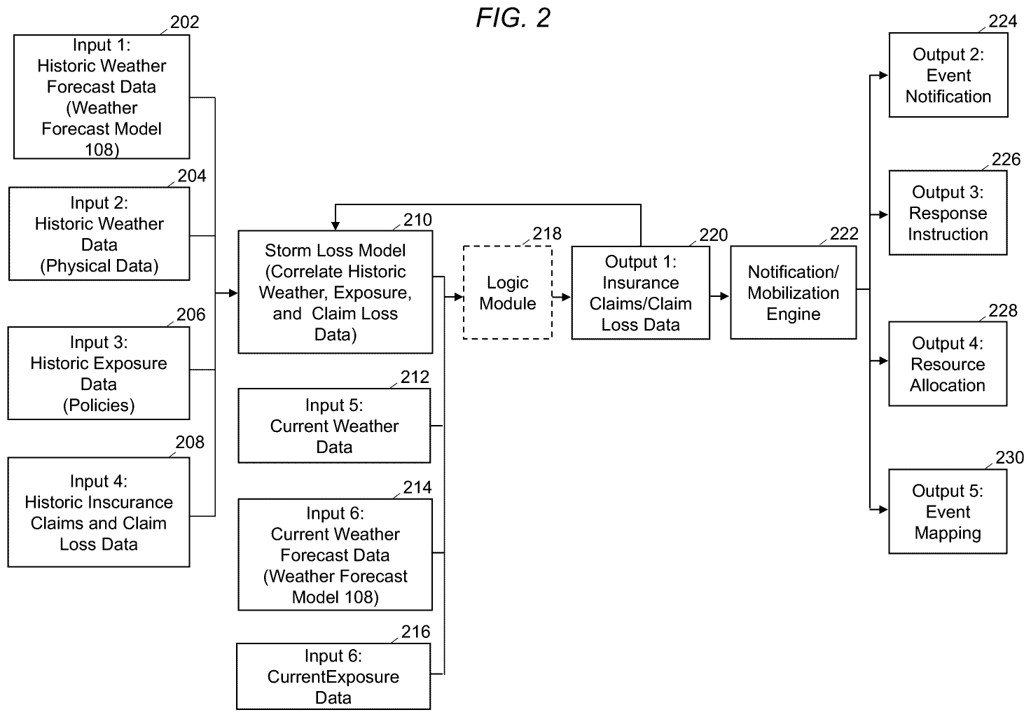

The storm loss model 110 is further in communication with one or more weather forecast model(s) 108 and one or more databases 130. The weather forecast model(s) 108 may receive current weather data from one or more databases 130 or, optionally, from one or more weather sensors 124. The weather forecast model(s) 108 may also receive historic weather data from one or more databases 130. In this configuration, the weather forecast model 108 may generate a current weather forecast using the current weather data. In addition, in this configuration, the weather forecast model 108 may also generate a historic weather forecast based on the historic weather data (i.e., reanalysis of historic weather data). The weather forecast data generated by the weather forecast model 108 may be received by the storm loss model 110. As described with reference to FIG. 2, historic weather forecast data may be used to train the storm loss model 110 and develop correlations between the historic weather forecasts and historic outcomes, such as historic insurance claims and claim losses, associated with a historic weather event. By some approaches, correlations may be developed via one or more machine learning algorithms. Using those correlations, the storm loss model 110 may be employed to predict likely outcomes, such as insurance claims and claim losses, associated with a predicted weather event based, at least in part, on current weather forecast data.

In some embodiments, the weather forecast models 108 may be numerical weather prediction models. The weather forecast models 108 may simulate the futures state of the atmosphere through time based on initial conditions, for example, based on weather data (e.g., historic or current) indicative of physical conditions of the atmosphere. By some approaches, the control circuit 122 may be configured to run the weather forecast models 122 in order to generate weather forecast data.

In some embodiments, the system may further include a logic module 112 that may perform ensembling methods using multiple weather forecast models and multiple machine learning algorithms to obtain better predictive performance of the storm loss models 110.

In one illustrative approach, the weather event mobilization and response system 100 may be employed to send notifications to one or more electronic user devices 102 regarding predicted outcomes, such as, for example, likely insurances claims and claim losses generated by the storm loss model 110. In this approach, the system 100 may include a historic weather event database 138 that includes historic weather event data such as historic insurance claim data, historic exposure data, historic weather data, and historic insurance claim loss data associated with one or more historic weather events. The system 100 may further include an insurance policy database 132 and an asset database 134 that include insurance claim exposure data. By some approaches, insurance claim exposure data is representative of the extent of potential insurance claims and losses that an insurer would have to cover as a result of a weather event (i.e., insurance claims may be a subset of exposure). The system 100 may also include at least one electronic user device 102 having a user interface 104, 106 and a control circuit 122 in communication with the at least one electronic user device 102 and the databases 138, 132, 134.

In such a configuration, the control circuit 122 receives historic insurance claim data, historic exposure data, historic weather data, and historic claim loss data from the historic weather event database 138. Using the received historic weather data, the control circuit 122 may generate a historic weather forecast (i.e., historic weather forecast data or reanalysis data) by analyzing the historic weather data via a weather forecast model 108. The control circuit 122 then analyzes the historic weather data, the historic insurance claim data, the historic exposure data, the historic claim loss data, and the historic weather forecast data via a storm loss model 110. By some approaches, the storm loss model 110 is configured to develop correlations between the historic weather data, historic weather forecast data, and historic exposure data and the historic insurance claim data and historic claim loss data. Through this analysis, the storm loss model 110 may develop correlations that are predictive of insurance claims and claim losses. These correlations may then be employed by the system 100 to predict insurance claims and claim losses based on current weather data, current weather forecast data, and current exposure data.

In this configuration, the control circuit 122 may be further configured to receive current weather data in order to generate predicted insurance claims and claim losses using correlations developed by the storm loss model 110. The current weather data may be received from a database 130, such as a weather database 136 or, optionally, from at least one weather sensor 124. The control circuit 122 may analyze current weather data via a weather forecast model 108 in order to generate a current weather forecast (i.e., current weather forecast data). The control circuit 122 may also receive current exposure data from an insurance policy database 132 and an asset database 134. Using the current weather forecast data, the control circuit 122 may identify at least one weather event. By some approaches, identifying a weather event includes identifying the time and geographic area of the weather event. Additionally, the control circuit 122 may determine one or more predicted insurance claims and/or claim losses associated with the identified weather event using current weather forecast data, current exposure data, and correlations developed by the storm loss model 110. By some approaches, the storm loss model 110 may compare current weather data, the current weather forecast data, and the current exposure data to the historic weather data, historic weather forecast data, and historic exposure data to predict insurance claims and/or claim losses that will likely result from the identified weather event.

By some approaches, the predicted insurance claims generated by the storm loss model 110 may be a number of insurance claims that are likely to be filed from the insurance policies in force prior to or at the time of the identified weather event. In some approaches, the storm loss model 110 may further predict various insurance claim attributes (e.g., first notice of loss or the time from weather event to claim filing). Similarly, the predicted claim losses generated by the storm loss model 110 may be the monetary value of insurance claims likely to be filed based on the insurance policies in force prior to or at the time of the identified weather event. Based on the predicted claims and/or claim losses associated with an identified weather event, the control circuit 122 may send one or more notifications, alerts, reports, maps, instructions, etc. to one or more electronic user devices 102. By some approaches, the notifications, alerts, reports, maps, instructions etc. may be presented on a user interface 104, 106 associated with the one or more electronic user devices. In this manner, the system 100 may be employed to send targeted and customized information to individuals, such as insurance company policyholders or employees. Furthermore, this information may be based on the types of insurance coverage obtained by the individual. For example, an individual who owns a vehicle and resides in an area that is likely to experience severe hail may receive notification about transferring the vehicle into a covered area or one where the vehicle is protected from the coming hailstorm. By way of another example, a homeowner in an area likely to experience flooding may receive customized communications, such as, those about potential remediation efforts available to the homeowner.

As illustrated in FIG. 1, the various components of the weather event mobilization and response system may communicate directly or indirectly, such as over one or more distributed communication networks, such as network 150. For example, network 150 may include LAN, WAN, Internet, cellular, Wi-Fi, and other such communication networks or combinations of two or more such networks.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 122 may be configured (for example, by using corresponding programming stored in a memory as will be well understood by those skilled in the art) to carry out one or more of the steps, actions, and/or functions described herein.

In some embodiments, the databases 130 illustrated in FIG. 1 may include one or more of a policy database 132, an asset database 134, a weather database 136, a historic weather event database 138, and a weather forecast model database 139.

The policy database 132 may include current exposure data from on one or more insurance policies currently in force. By some approaches, exposure data may include information from one or more auto, property, and/or commercial insurance policies currently in force. By some approaches, current exposure data includes information from one or more insurance policies that is representative of the extent of potential losses that an insurer may have to cover as a result of a weather event. For example, current exposure data in the policy database 132 may include policy information such as: the person(s), business, or entity being insured; the risks or property covered; the policy liability limit; the premium amount; the deductible amount; the policy period (i.e., the time period the policy is in force); conditions that must be met for policy coverage to apply when a loss occurs; excluded losses; etc.

The asset database 134 may include data one or more assets associated with an insurance policy. Information stored in the asset database 134 may include, for example, characteristics the covered asset (e.g., asset value, vehicle make, vehicle model, vehicle identification number, construction materials, roof material, siding material, etc.) as well as geospatial data that is indicative the asset's location.

The weather database 136 may include current weather data. Current weather data may be defined as real-time weather data. Similarly, anything that is not real-time weather data may be classified as historic weather data. Current weather data stored in the weather database 136 may include, for example, information on wind speed, wind direction, hail size, hail density, etc. By some approaches, sources for current weather data may include information from one or more sensors, radar, storm reports, upper level soundings, amount of precipitation, form of precipitation, precipitation intensity, precipitation duration, etc. Additional sources for current weather data may include networks of sensors and/or weather radars such as, for example, Next-Generation Radar (Nexrad). In some configurations, the system 100 may also optionally include one or more weather sensors 124 that collect weather data. Data collected by the one or more weather sensors 124 may be stored in the weather database 136.

The historic weather event database 138 may include information associated with one or more historic weather events. By some approaches, the historic weather event database 138 may include historic weather data associated with a historic weather event. Historic weather data may include meteorological information that was collected during or prior to the historic weather event. The historic weather data may include, for example, information on wind speed, wind direction, hail size, hail density, amount of precipitation, form of precipitation, precipitation intensity, precipitation duration, etc. collected prior to or during the historic weather event. By some approaches, sources for the historic weather data may include information from one or more weather sensors, radar devices, storm reports, upper level soundings, etc. Additional sources for historic weather data may include networks of sensors and/or weather radars such as, for example, Next-Generation Radar (Nexrad). In addition to historic weather data, the historic weather event database 138 may include historic exposure data from on one or more insurance policies that were in force at the time of the historic weather event.

In some embodiments, the historic exposure data is representative of the extent of potential insurance claims and losses that an insurer would have to cover as a result of a historic weather event. Furthermore, the historic weather event database 138 may include outcomes associated with a historic weather event, such as historic insurance claim data and historic claim loss data. Historic insurance claim data may include the types of insurance claims and the volume of insurance claims that resulted from a historic weather event. In some embodiments, the historic insurance claim data may further include data on various attributes of insurance claims (e.g., first notice of loss, time from weather event to claim filing) resulting from a historic weather event. By some approaches, the historic claim loss data may include a monetary value of insurance claims filed as a result of a historic weather event. In other approaches, the historic claim loss data may include an amount of damage to one or more assets, for example, assets covered by an insurance policy. By other approaches, the historic insurance claim data and/or the historic claim loss data may represent a percentage of an insurer's total exposure (i.e., potential claims and/or losses that an insurer may have to cover as a result of a weather event). In one example, the historic insurance claims data may be a percentage representing the actual number claims filed as a result of a historic weather event relative to the total claim exposure for the historic weather event. In another example, the historic claim loss data may be a percentage representing the total claim losses paid as a result of a historic weather event relative to the total claim loss exposure for the historic weather event. Thus, historic insurance claim data and/or historic claim loss data may be a subset of historic exposure data.

By some approaches, historic claim loss data in the historic weather event database 138 may also include other outcomes or observations associated with a historic weather event. Other outcomes may include, for example, information regarding insurance loss adjustments, resource use (e.g., an amount of money, a quantity of raw materials), or asset impact (e.g., extent of damage, number of damaged assets) associated with the historic weather event.

The weather forecast model database 139 may include weather forecast data generated by the weather forecast model 108. The weather forecast model database 139 may include one or more of current weather forecast data and historic weather forecast data.

FIG. 2 is a schematic illustration of an exemplary weather event mobilization and response system in accordance with some embodiments. More specifically, FIG. 2 details how a storm loss model 210 operates in conjunction with a notification/mobilization engine 222 in an exemplary weather event mobilization and response system. In operation, the weather event mobilization and response system may develop and/or train a storm loss model 210 by analyzing historic weather event data (i.e., historic weather forecast data 202, historic weather data 204, historic exposure data 206, historic insurance claim data 208, and historic claim loss data 208) to develop correlations predictive of insurance claims and claim losses. Once developed and/or trained, the storm loss model 110 may be used to predict insurance claims and claim losses based on current data (i.e., current weather forecast data 212, current weather data 214, and current exposure data 216).

As depicted in FIG. 2, the storm loss model 210 may receive historic weather forecast data 202, historic weather data 204, historic exposure data 206, historic insurance claim data 208, and historic claim loss data 208. In some embodiments, the storm loss model 210 may develop correlations or relationships between historic weather forecast data 202, historic weather data 204, and historic exposure data 206 and historic outcomes, such as insurance claim data 208 and historic claim loss data 208.

By some approaches, the storm loss model 210 may develop correlations between historic observations (e.g., historic weather data, historic weather forecast data, historic exposure data) and historic outcomes associated with a historic weather event (e.g., historic insurance claims, historic claim losses) using one or more machine learning algorithms. Machine learning methodologies employed by the system may include may use Bayesian, Tree-based methods, Clustering algorithms, Copula-based, Deep Neural Networks, or combinations thereof. Tree-based method may include, for example, Gradient Boosting Machines, Random Forests, XGBoost, etc. The machine learning algorithms may be trained using historic examples to produce predictive models that can be applied to current observations. The machine learning algorithms may analyze historic weather event data to learn which data are predictive of outcomes such as insurance claims and claim losses. Correlations developed by the machine learning algorithms may be designed to predict outcomes (e.g., insurance claims, claim losses) given current observations (e.g., current weather data, current weather forecast data, and current exposure data). The machine learning algorithms may be implemented by a processor or logic associated with a control circuit or by some other computing system, such as the one or more server computer systems.

By some approaches, actual outcomes, such as actual insurance claims and claims losses, resulting from a weather event may be input into the storm loss model 210 to continuously re-inform the storm loss model. That is, after the storm loss model 210 generates predicted insurance claims and claim losses for a particular weather event, the actual observed insurance claims and claims losses may then be used as a new example to train the storm loss model 210.

Furthermore, in some approaches, the system may optionally include a logic module 218 that develops an ensemble of storm loss models 210 designed to predict expected insurance claims and claim losses given current weather data, current weather forecast data, and current exposure data.

Using the correlations developed by the storm loss model 210, the system may predict outcomes, such as insurance claims and/or claim losses 220, based on current weather forecast data 212, current weather data 214, and current exposure data 216. Based on the predicted outcomes, such as insurance claims and/or claim losses 220, a notification/mobilization engine 222 may generate one or more responses or mobilize resources. In some embodiments, the notification/mobilization engine 222 may generate weather event notifications 224, response instructions 226, resource allocation 228, and/or event mapping 230 based on predicted outcomes (e.g., insurance claims and claim losses 220).

By some approaches, the weather event notification 224 may include a notification sent to one or more electronic user devices. For example, one or more weather event notifications 224 may be transmitted to an electronic user device associated with a customer of an insurer (e.g., a policyholder). In another example, one or more weather event notifications may be transmitted to an electronic user device associated with an employee of an insurer. By some approaches, the weather event notification 224 may take the form of a report generated to display predicted insurance claims, predicted claim losses, or other data on predicted outcomes generated by the storm loss model. For example, the report may display a predicted volume of insurance claims, a predicted volume of insurance claims by claim type, and/or a predicted monetary value of insurance claims. In other approaches, the notification may be an alert for a customer alerting the customer to possible damage to one or more assets, such as a home or a vehicle, that the storm loss model predicts will result in an insurance claim or claim loss.

By some approaches, the response instructions 226 may include instructions for a customer of an insurer (e.g., a policyholder), an employee of an insurer, or a third party such as a contractor that is impacted by an insurance claim. Instructions may include instructions for preparing for and/or responding to a weather event identified by the storm loss model. By some approaches, instructions may instruct an employee of an insurer to allocate resources such as money, staff, manpower, assets, time, or raw materials for preparing for and/or responding to an identified weather event. For example, the response instructions may be instructions to allocate a quantity of raw materials, instructions to assign a number of employees to a particular task, instructions to move or take other action with respect to a particular asset located within the geographic area associated with the weather event, or instructions to allocate an amount of money in order to prepare for and/or respond to the weather event and predicted outcomes (e.g, insurance claims, claim losses). In one example, instructions may be sent to an employee of an insurer to increase staffing for a particular task (e.g., call center staffing, insurance adjuster staffing) if there is a high volume of predicted insurance claims.

By some approaches, resource allocation 228 may include the automated allocation of one or more resources for preparing for and/or responding to a weather event or predicted insurance claims identified by the storm loss model. The resources allocated by the system may include money, manpower, time, assets, and/or physical resources such as raw materials. In one approach, the weather event mobilization and response system may be integrated with one or more insurance claim workflow systems to facilitate the allocation of resources. In some approaches, the notification/mobilization engine 222 may be in integrated with other systems that facilitate the allocation of resources. In one example, the notification/mobilization engine 222 may be integrated with a warehouse system or distribution center system to allocate inventory that will likely be required for handling damages associated with insurance claims resulting from a weather event. In another example, the notification/mobilization engine 222 may be integrated with a supply chain management system for ordering one or more materials that will likely be required for handling damages associated with insurance claims result for a weather event. In another example, the notification/mobilization engine 222 may be integrated with a contractor management system to prepare contractor quotes that could be transmitted to a customer of an insurer (e.g., a policyholder) based on predicted insurance claims. In another example, resource allocation may involve communicating with a financial system to allocate an amount of money that will be required to address predicted outcomes, such as insurances claims and/or claim losses.

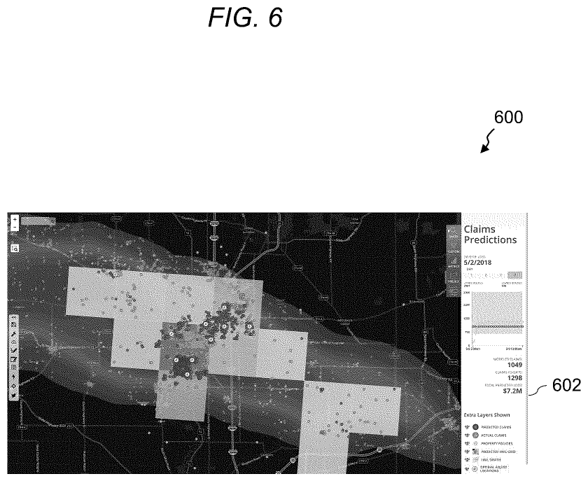

In some approaches, the event mapping 230 may include a geographic representation of predicted outcomes, such as insurance claims and/or claim losses, generated by the storm loss model 110. By some approaches, the event mapping 230 may display predicted insurance claims and/or claim losses over time as well as over a geotropic area. FIG. 6 illustrates an example insurance claim visualization screen that includes an event mapping.

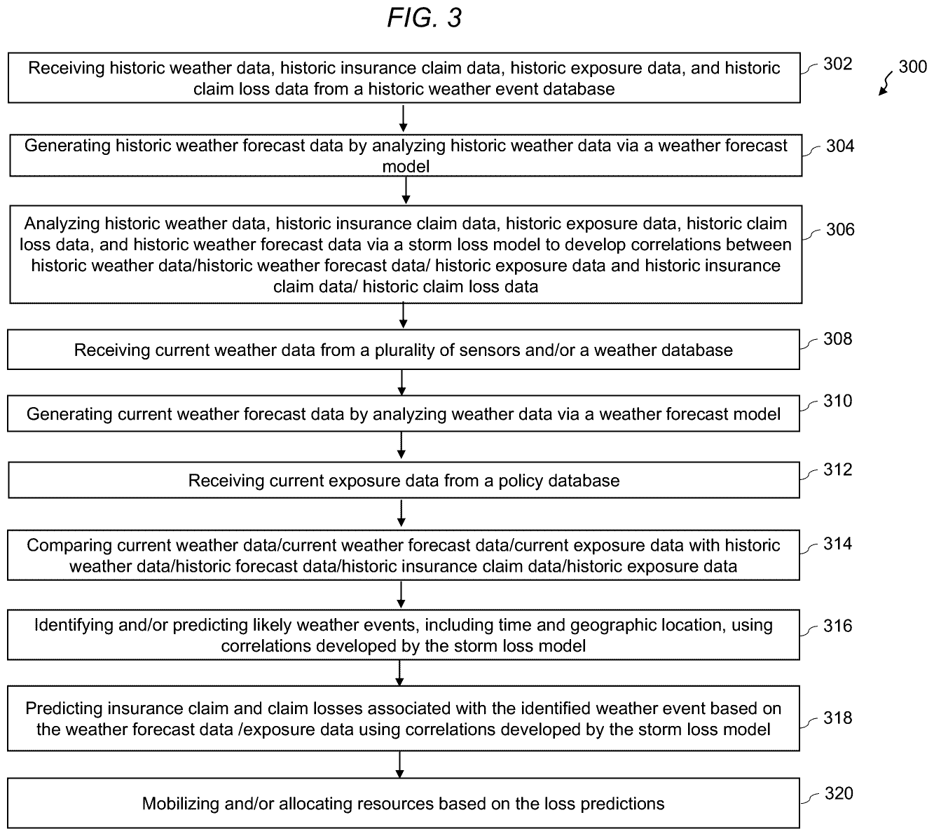

To illustrate how the weather event mobilization and response system may be employed to mobilize resources or generate responses in preparation for and/or response to weather events, illustrative methods are described herein. Methods of operating the weather event mobilization and response system are described with reference to FIGS. 3-5.

In one exemplary embodiment, a method is provided herein for operating the weather event mobilization and response system 100 to mobilize and/or allocate resources based on predicted claims and/or predicted claim losses. FIG. 3 is a diagram illustrating a method 300 of operating a weather event mobilization and response system to mobilize and/or allocate resources for a weather event.

By one approach, the method 300 includes receiving 302 historic weather data, historic insurance claim data, historic exposure data, and historic claim loss data from one or more databases such as, for example, the historic weather event database 138 as is described with reference to FIG. 1.

The method 300 may further include generating 304 a historic weather forecast by analyzing historic weather data. By some approaches, the step of generating 304 historic weather data may be performed by a weather forecast model such as, for example, the weather forecast model 108 described with reference to FIG. 1. In some approaches, the weather forecast model may be a numerical weather prediction model.

The method 300 also includes analyzing 306 historic weather data, historic insurance claim data, historic exposure data, historic claim loss data, and historic weather forecast data. By some approaches, the step of analyzing 306 historic weather data, historic insurance claim data, historic exposure data, historic claim loss data, and historic weather forecast data may be performed by a storm loss model, for example, the storm loss model 110 described with reference to FIG. 1. By some approaches, analyzing 306 may include developing correlations between historic weather data, historic weather forecast data, and historic exposure data and one or more outcomes of a historic weather event, such as historic insurance claim data and historic claim loss data, to develop a predictive model. In some embodiments, correlations may predictive of insurance claims or claims losses. By some approaches, analyzing 306 may include training the storm loss model using one or more machine learning algorithms. In some embodiments, the system may analyze other outcomes associated with a historic weather event. For example, the storm loss model may develop correlations using outcomes, such as resource (e.g., money, manpower, time, assets, and/or physical resources such as raw materials) usage, associated with a historic weather event. Thus, the storm loss model may develop correlations that are predictive of other outcomes such as resource (e.g., money, manpower, time, assets, and/or physical resources such as raw materials) usage.

The method 300 further includes receiving 308 current weather data and generating 310 a current weather forecast using the current weather data. By some approaches, the current weather data may be received via one or more weather sensors, one or more databases, or a combination thereof. In some approaches, generating 310 a current weather forecast may be done using a weather forecast model such as, for example, the weather forecast model 108 described with reference to FIG. 1.

In addition, the method 300 includes receiving 312 current exposure data. By some approaches, the system may receive current exposure data from a database such as, for example, the policy database 132 described with reference to FIG. 1.

Further, the method includes comparing 314 current weather data, current weather forecast data, and current exposure data with historic weather data, historic weather forecast data, historic insurance claim data, and historic exposure data. After comparing 314 current and historic data, the system may identify and/or predict 316 likely weather events. By some approaches, identifying and/or predicting 316 likely weather events includes predicting a time and geographic area for the weather events. In addition to identifying and/or predicting 316 likely weather events, the method may also include predicting 318 one or more outcomes such as insurance claims and/or resulting claim losses associated with such weather events. Based on data analyzed by the storm loss model, by some approaches, predicting 318 may also including predicting other outcomes, such as resource (e.g., money, manpower, time, assets, and/or physical resources such as raw materials) usage, associated with such weather events.

In some embodiments, predicting 318 one or more insurance claims (i.e., insurance claim data) may include predicting the types of insurance claims and/or the volume of insurance claims likely to result from an identified and/or predicted weather event. In some embodiments, predicting 318 one or more insurance claims may include predicting various attributes (e.g., first notice of loss, time from weather event to claim filing) associated with insurance claims likely to result from an identified and/or predicted weather event. In some embodiments, predicting 318 one or more claim losses (i.e., claim loss data) may include predicting a monetary value of insurance claims likely to be filed as a result of an identified and/or predicted weather event. In some embodiments, the predicted claim loss data may include an amount of damage to one or more assets, for example, assets covered by an insurance policy. In other embodiments, the predicted insurance claim data and/or the historic claim loss data may represent a percentage of an insurer's total exposure (i.e., the percentage of potential claims and/or losses that an insurer may have to cover as a result of a weather event).

In response to the predicted outcomes, method 300 may include mobilizing and/or allocating 320 resources based on the predicted outcomes (e.g., based on predicted insurance claims and/or claim losses). The resources mobilized and/or allocated by the system may include money, manpower, time, assets, and/or physical resources such as raw materials. In some embodiments, the weather event mobilization and response system may be integrated with one or more claims workflow systems to facilitate the mobilization and/or allocation of resources. In some embodiments, the weather event mobilization and response system may be in integrated with other systems that facilitate the allocation of resources. Such other systems may include, for example, distribution systems, warehouse systems, supply chain management systems, staffing systems, financial systems, etc. In one illustrative approach, allocating resources may include communicating with a supply chain management system to generate orders for one or more raw materials. In another example, allocating resources may involve communicating with a warehouse system or distribution center system to allocate inventory that will likely be required for handling damages associated with insurance claims resulting from a weather event. In another example, allocating resources may involve communicating with a financial system to allocate an amount of money that will be required to address predicted insurances claims and/or claim losses. In some examples, the mobilization of resources may include the deployment of adjusters or the deployment of third-party administrators. In one example, the deployment of resources may include the deployment of a drone imagery network.

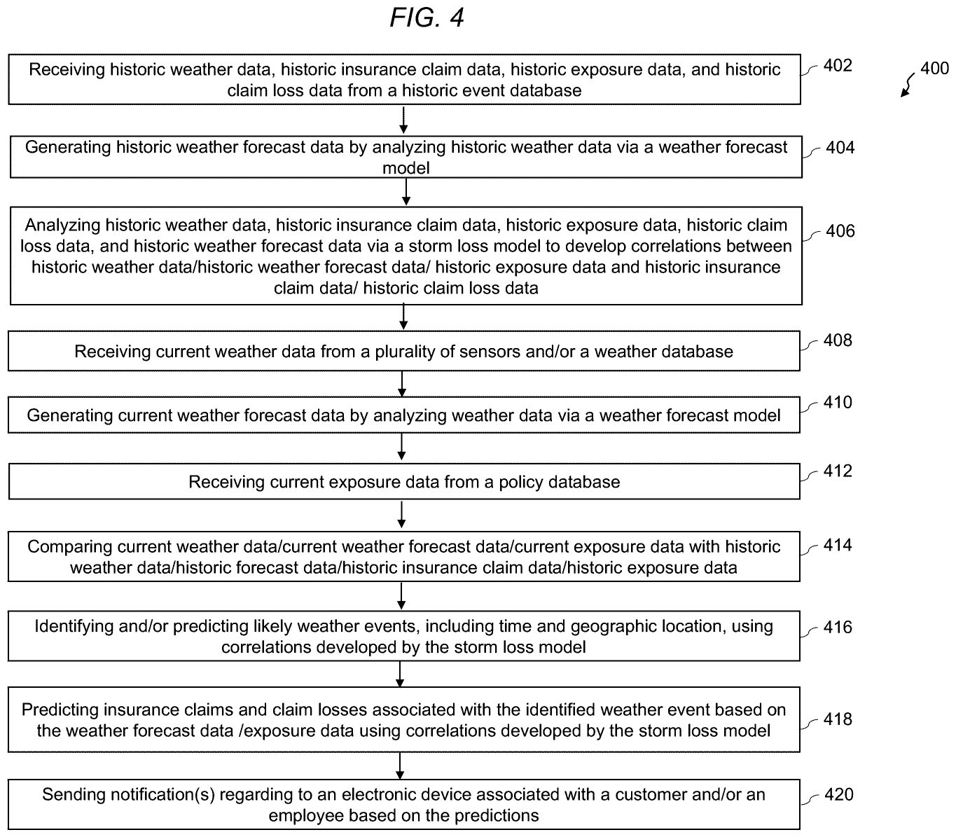

In another exemplary embodiment, a method is provided herein for operating the weather event mobilization and response system 100 to send a notification regarding predicted claims and/or claim losses to an electronic device associated with a customer and/or an employee of an insurer. FIG. 4 is a diagram illustrating a method 400 of operating a weather event mobilization and response system to send a notification.

By one approach, the method 400 includes receiving 402 historic weather data, historic insurance claim data, historic exposure data, and historic claim loss data from one or more databases such as, for example, the historic weather event database 138 as is described with reference to FIG. 1.

The method 400 may further include generating 404 historic weather forecast data by analyzing historic weather data (i.e., reanalysis data). By some approaches, the step of generating 404 historic weather data may be done use a weather forecast model such as, for example, the weather forecast model 108 described with reference to FIG. 1. In some approaches, the weather forecast model may be a numerical weather prediction model.

The method 400 also includes analyzing 406 historic weather data, historic insurance claim data, historic exposure data, historic claim loss data, and historic weather forecast data. By some approaches, the step of analyzing 406 historic weather data, historic insurance claim data, historic exposure data, historic claim loss data, and historic weather forecast data may be performed by a storm loss model, for example, the storm loss model 110 described with reference to FIG. 1. By some approaches, analyzing 406 may include developing correlations between historic weather data, historic weather forecast data, and historic exposure data and one or more outcomes such as, historic insurance claim data and historic claim loss data, to develop a predictive model. In some embodiments, correlations may predictive of outcomes such as insurance claims or claims losses. By some approaches, analyzing 406 may include training the storm loss model using one or more machine learning algorithms. In some embodiments, the system may analyze other outcomes associated with a historic weather event. For example, the storm loss model may use other outcomes, such as resource (e.g., money, manpower, time, assets, and/or physical resources such as raw materials) usage, associated with a historic weather event. Thus, the storm loss model may develop correlations that are predictive of other outcomes, such as resource (e.g., money, manpower, time, assets, and/or physical resources such as raw materials) usage.

The method 400 further includes receiving 408 current weather data and generating 410 a current weather forecast using the current weather data. By some approaches, the current weather data may be received via one or more weather sensors, one or more databases, or a combination thereof. In some approaches, generating 410 a current weather forecast may be done using a weather forecast model such as, for example, the weather forecast model 108 described with reference to FIG. 1.

In addition, the method 400 includes receiving 412 current exposure data. By some approaches, the system may receive current exposure data from a database such as, for example, the policy database 132 described with reference to FIG. 1.

Further, the method includes comparing 414 current weather data, current weather forecast data, and current exposure data with historic weather data, historic forecast data, historic insurance claim data, historic exposure data. After comparing 414 current and historic data, the system may identify and/or predict 416 likely weather events. By some approaches, identifying and/or predicting likely weather events includes predicting a time and geographic area for the weather events. In addition to identifying and/or predicting 416 likely weather events, the method may also include predicting 418 one or more outcomes, such as insurance claims and/or claim losses, associated with such weather events. Based on data analyzed by the storm loss model, by some approaches, predicting 418 may also including predicting other outcomes, such as resource (e.g., money, manpower, time, assets, and/or physical resources such as raw materials) usage, associated with such weather events.

In some embodiments, predicting 418 one or more insurance claims (i.e., insurance claim data) may include predicting the types of insurance claims and/or the volume of insurance claims likely to result from an identified and/or predicted weather event. In some embodiments, predicting 418 one or more insurance claims may include predicting various attributes (e.g., first notice of loss, time from weather event to claim filing) associated with insurance claims likely to result from an identified and/or predicted weather event. In some embodiments, predicting 418 one or more claim losses (i.e., claim loss data) may include predicting a monetary value of insurance claims likely to be filed as a result of an identified and/or predicted weather event. In some embodiments, the predicted claim loss data may include an amount of damage to one or more assets, for example, assets covered by an insurance policy. In other embodiments, the predicted insurance claim data and/or the historic claim loss data may represent a percentage of an insurer's total exposure (i.e., the percentage of potential claims and/or losses that an insurer may have to cover as a result of a weather event).

The method 400 may further include sending 420 a notification to one or more customers and/or employees of an insurer based on the identified outcome (e.g., insurance claims and/or claim losses). Sending a notification to one or more customers may include, for example, the deployment of a digital communication to one or more insurance policyholders. By some approaches, the notification may be an electronic report identifying predicted insurance claims and claim losses associated with the identified weather event. In other approaches, the notification may include instructions for responding to the identified weather event. In one illustrative example, a notification may be sent to the customer of an insurer to instruct and/or recommend a particular action be taken in preparation or in response to predicted insurance claims or claim losses. For example, the notification may instruct a customer to move a vehicle into a garage based on a predicted insurance claim identified by the storm loss model. In another example, the notification may instruct a customer to close windows and/or doors or to anchor potential projectiles based on a predicting insurance claim identified by the storm loss model. In another illustrative example, a notification may be sent to an employee of an insurer to instruct the employee to take a particular action in preparation for and/or in response to predicted insurance claims. For example, a notification may instruct an employee to staff a call center for a predicted weather event based on a volume of predicted insurance claims identified by the storm loss model 110.

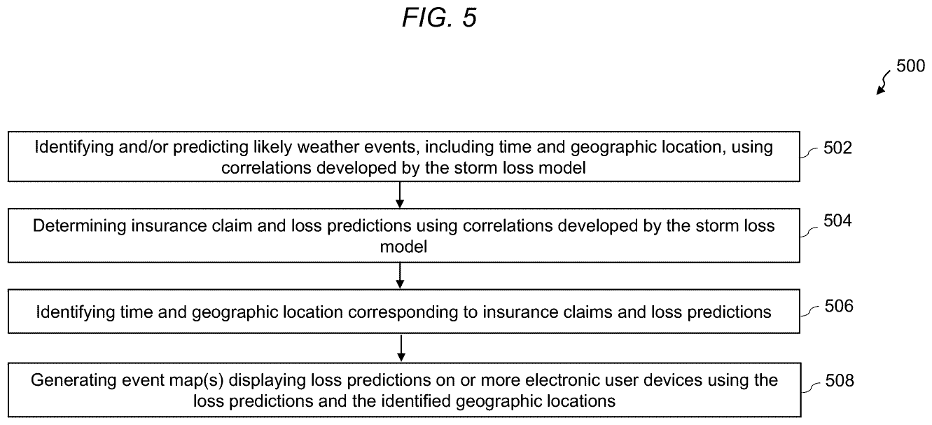

In one exemplary embodiment, a method is provided herein for operating a weather event mobilization and response system to display a geographic representation of predicted claims and/or predicted claim losses. FIG. 5 is an exemplary flow diagram illustrating a method 500 of operating a weather event mobilization and response system to provide a claim loss visualization. By some approaches, the method of FIG. 5 may be performed by the weather event mobilization and response system depicted in FIG. 1.

The method 500 includes identifying and/or predicting 502 one or more likely weather events using correlations developed by a storm loss model, such as, for example, the storm loss model(s) 110 described above. The method also includes determining 504 one or more predicted outcomes, such as insurance claims and/or claim losses, using correlations developed by the storm loss model. In addition to determining 504 one or more predicted outcomes (e.g., insurance claims and claim losses), the method includes identifying 506 a time and geographic area corresponding to the one or more predicted outcomes (e.g., insurance claims and/or claim losses). The method 500 may then further include generating 508 an event map displaying the outcomes, such as insurance claims and/or claim losses, at the identified locations on a user interface of electronic device. By some approaches, the event map further provides visual a representation of insurance claims and/or claim losses over a period of time.

FIG. 6 is an exemplary claims data visualization screen 602 in accordance with several embodiments. By some approaches, the claims data visualization screen 602 may be generated using the method 500 described with reference to FIG. 5.

In some embodiments, the claims data visualization screen may be displayed on one or more electronic user devices, such as the electronic user devices 102 described with reference to FIG. 1. In one example, the claims data visualization screen 602 may be displayed on one or more customer user interfaces 104. In another example, the claims data visualization screen 602 may be displayed on one or more employee user interfaces 106.

By some approaches, the claims data visualization screen 602 may include a map displaying predicted outcomes such as insurance claims and/or predicted claim losses associated with a weather event. The claims data visualization screen 602 may display predicted outcomes such as insurance claims or predicted claim losses over time and geographic area. In one illustrative approach, the claims data visualization screen 602 may include a color gradient that is indicative of a number of predicted claims. In another illustrative approach, the claims data visualization screen 602 may include a color gradient indicative that is indicative of a monetary value for the predicted claim losses.

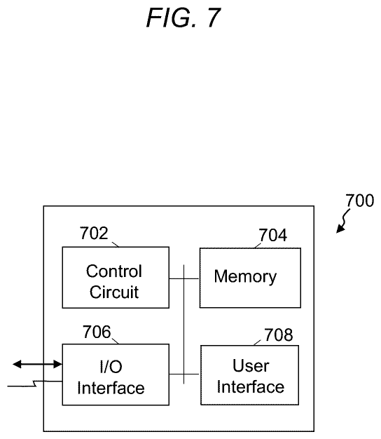

The methods, techniques, systems, devices, services, servers, sources and the like described herein may be utilized, implemented and/or run on many different types of devices and/or systems. Referring to FIG. 7, there is illustrated a system 700 that may be used for any such implementations, in accordance with some embodiments. One or more components of the system 700 may be used to implement any system, apparatus or device mentioned above, or parts of such systems, apparatuses or devices, such as for example any of the above or below mentioned control circuits, electronic user devices, sensor(s), databases, parts thereof, and the like. However, the use of the system 700 or any portion thereof is, certainly not required.

By way of example, the system 700 may include one or more control circuits 702, memory 704, input/output (I/O) interface 706, and/or user interface 708. The control circuit 702 typically comprises one or more processors and/or microprocessors. The memory 704 stores the operational code or set of instructions that is executed by the control circuit 702 and/or processor to implement the functionality of the systems and devices described herein, parts thereof, and the like. In some embodiments, the memory 704 may also store some or all of particular data that may be needed to assist with providing an accurate temporal prediction of the volume and location of expected insurance claims resulting from a weather event and potential responses or mobilization efforts in response to such identification.

It is understood that the control circuit 702 and/or processor may be implemented as one or more processor devices as are well known in the art. Similarly, the memory 704 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 704 is shown as internal to the system 700; however, the memory 704 can be internal, external or a combination of internal and external memory. The system 700 also may include a database (not shown in FIG. 7) as internal, external, or a combination of internal and external to the system 700. Additionally, the system typically includes a power supply (not shown), which may be rechargeable, and/or it may receive power from an external source. While FIG. 7 illustrates the various components being coupled together via a bus, it is understood that the various components may actually be coupled to the control circuit 202 and/or one or more other components directly.

Generally, the control circuit 702 and/or electronic components of the system 700 can comprise fixed-purpose hard-wired platforms or can comprise a partially or wholly programmable platform. These architectural options are well known and understood in the art and require no further description here. The system and/or control circuit 702 can be configured (for example, by using corresponding programming as will be well understood by those skilled in the art) to carry out one or more of the steps, actions, and/or functions described herein. In some implementations, the control circuit 702 and the memory 704 may be integrated together, such as in a microcontroller, application specification integrated circuit, field programmable gate array or other such device, or may be separate devices coupled together.

The I/O interface 706 allows wired and/or wireless communication coupling of the system 700 to external components and/or or systems. Typically, the I/O interface 706 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 710 may be used for user input and/or output display. For example, the user interface 710 may include any known input devices, such one or more buttons, knobs, selectors, switches, keys, touch input surfaces, audio input, and/or displays, etc. Additionally, the user interface 710 include one or more output display devices, such as lights, visual indicators, display screens, etc. to convey information to a user, such as but not limited to communication information, instructions regarding unloading of the delivery vehicle, status information, order information, delivery information, notifications, errors, conditions, and/or other such information. Similarly, the user interface 710 in some embodiments may include audio systems that can receive audio commands or requests verbally issued by a user, and/or output audio content, alerts and the like.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A damage response system comprising:
a drone imagery network;
one or more sensors configured to collect current weather data; and
a processor in communication with the one or more sensors and the drone imagery network, the processor having at least one memory device storing a weather prediction model configured to generate weather predictions that simulate future states of the atmosphere through time based on weather data and a storm impact model, the processor configured to:
receive weather training data, property training data, and property damage training data from a database;
generate weather prediction training data by analyzing the weather training data via the weather prediction model;
train the storm impact model via at least one machine learning algorithm using the weather prediction training data, the property training data, and the property damage training data to generate a trained storm impact model that includes relationships between the weather prediction training data and the property training data and the property damage training data;
receive the current weather data from the one or more sensors;
generate a current weather prediction by analyzing the current weather data via the weather prediction model;
receive current property data from a database;
determine, via the trained storm impact model, predicted property damage based on the current weather prediction and the current property data; and
deploy a drone imagery network based on the predicted property damage.

2. The damage response system of claim 1, wherein the processor is further configured to:
identify an area associated a weather event based on the current weather prediction using the trained storm impact model;
receive location data indicative of property location from the database;
identify at least one property by comparing the location data to the area associated with the weather event; and
deploy the drone imagery network further based on the at least one property.

3. The damage response system of claim 2, wherein current property data includes data on the at least one property.

4. The damage response system of claim 2, wherein the at least one property includes at least one of a home or a vehicle.

5. The damage response system of claim 1, wherein the processor is further configured to:
transmit a notification to one or more user devices based on the predicted property damage.

6. The damage response system of claim 1, wherein the processor is further configured to:
transmit response instructions to one or more user devices based on the predicted property damage.

7. The damage response system of claim 6, wherein the response instructions include instructions to move or take action with respect to a particular property.

8. The damage response system of claim 1, wherein the processor is further configured to:
cause a visualization of a mapping of the predicted property damage to be provided via one or more user devices.

9. The damage response system of claim 1, wherein the processor is further configured to:
allocate physical resources to a particular property based on the predicted property damage.

10. The damage response system of claim 9, wherein the processor is in communication with a warehouse system and the processor is configured to allocate the physical resources to the particular property via the warehouse system.

11. The damage response system of claim 9, wherein the processor is in communication with a distribution center system and the processor is configured to allocate the physical resources to the particular property via the distribution center system.

12. The damage response system of claim 1, wherein the current weather data includes at least one of wind speed, wind duration, hail size, hail density, an amount of precipitation, a form of precipitation, a precipitation intensity, or a precipitation duration.

13. The damage response system of claim 1, wherein the weather training data includes at least one of wind speed, wind duration, hail size, hail density, an amount of precipitation, a form of precipitation, a precipitation intensity, or a precipitation duration collected prior to a past weather event.

14. The damage response system of claim 1, wherein the processor is further configured to:
cause physical resources to be deployed to a particular property based on the predicted property damage.

15. The damage response system of claim 1, wherein the property training data includes information on one or more properties associated with a past weather event.

16. The damage response system of claim 15, wherein the property training data includes at least one of an identification number, materials of construction, model, or make associated with the one or more properties.

17. The damage response system of claim 1, wherein the current weather data is real-time weather data.

18. The damage response system of claim 1, wherein the property damage training data includes information on an impact of a past weather event on one or more properties.

19. The damage response system of claim 18, wherein the property damage training data includes information on an impact of the past weather event on the one or more properties.

20. The damage response system of claim 18, wherein the damage response system further includes a network of radar devices and wherein at least a portion of the weather data is received from the network of radar devices.
